(19) United States
(12) Patent Application Publication
(10) Pub. No.: US 2026/0195659 A1
(43) Pub. Date: Jul. 9, 2026

(54) WEATHER MODELLING

(71) Applicant: Sorcerer Space Company, New Orleans, LA (US)

(72) Inventor: Robert Keenan FORNEY, New Orleans, LA (US)

(21) Appl. No.: 19/437,795

(22) Filed: Dec. 31, 2025

Related U.S. Application Data
(60) Provisional application No. 63/741,770, filed on Jan. 3, 2025.

(51) Int. Cl. G06N 20/20

(52) U.S. Cl. CPC G06N 20/20

(57) ABSTRACT

A computer-implemented method of training a first machine learning model to determine a local weather modifier, the method comprising: obtaining a first training data set comprising a plurality of training samples, each training sample comprising an observed local weather modifier in a geographical region and one or more geographic features of the geographical region, wherein each geographic feature has a feature location and a feature property; training the first machine learning model to predict a local weather modifier for another geographical region based on one or more geographic features of the other geographical region.

### CROSS-REFERNECE TO RELATED APPLICATION

The present application claims priority to and the benefit of U.S. Provisional Patent Application No. 63/741770, filed on January 3, 2025, the contents of which are incorporated herein by reference in their entirety.

### TECHNICAL FIELD

The following disclosure relates to methods and systems for modelling weather, and in particular methods and systems for determining and analyzing local weather modifiers and providing improved prediction and risk analysis of weather.

### BACKGROUND

Existing weather modelling techniques can use measurements of pressure, temperature and other properties at ground level and/or atmospheric level in order to establish a current weather state. An atmospheric model is then applied in order to predict a future weather state.

Additionally, imaging techniques such as radar can be used to predict, identify and track weather features such as clouds, storm conditions, hail conditions, cyclones or tornadoes.

However, most widely-used weather prediction systems are mesoscale or global systems, with a resolution of no less than a few kilometers. For example, the North American Mesoscale (NAM) Forecast System and the High Resolution Rapid Refresh (HRRR) models provide regional forecasts in the United States of America at a grid resolution of about 3km.

Some microscale weather prediction techniques have been studied, to take into account local factors such as urban heat island effects. However, these techniques are generally not easily transferrable between different local areas or scalable to larger areas while maintaining their resolution.

As a result, it is desirable to provide improved weather prediction techniques which can be deployed to make higher resolution predictions over larger areas.

### SUMMARY

The application provides models for predicting a local weather modifier based on observed geographic features, and models for predicting geographic features based on an observed local weather modifier.

A predicted local weather modifier can be used for various purposes including improving the resolution and/or accuracy of weather forecasts derived from a model, and/or improving the resolution and/or accuracy of weather risk analysis over longer time periods.

A predicted geographic feature can be investigated to discover unmapped features such as factories (which can affect weather due to, for example, heat emission or particulate emissions).

The application also provides techniques for training such machine learning models.

According to an aspect, the following specification provides a computer-implemented method of training a first machine learning model to determine a local weather modifier, the method comprising: obtaining a first training data set comprising a plurality of training samples, each training sample comprising an observed local weather modifier in a geographical region and one or more geographic features of the geographical region, wherein each geographic feature has a feature location and a feature property; and training the first machine learning model to predict a local weather modifier for another geographical region based on one or more geographic features of the other geographical region.

According to another aspect, the following specification provides a computer-implemented method of training a second machine learning model to determine a geographical feature, the method comprising: obtaining a second training data set comprising a plurality of training samples, each training sample comprising a local weather modifier in a geographical region and one or more observed geographic features of the geographical region, wherein each geographic feature has a feature location and a feature property; and training the second machine learning model to predict one or more geographic features of another geographical region based on a local weather modifier for the other geographical region.

### BRIEF DESCRIPTION OF THE DRAWINGS

FIGS. 1A and 1B are flow diagrams schematically illustrating alternative methods of determining a local weather modifier;

FIGS. 2A and 2B are block diagrams schematically illustrating a model for predicting a local weather modifier and a system for training the model;

FIGS. 3A and 3B are flow diagrams schematically illustrating applications of a local weather modifier, for predicting weather risk or for improving weather predictions;

FIG. 4 is a flow chart schematically illustrating steps of a method for predicting weather risk;

FIG. 5 is a flow chart schematically illustrating steps of a method for predicting weather;

FIG. 6 is a flow chart schematically illustrating steps of a method for training a model to predict a local weather modifier;

FIG. 7 is a flow chart schematically illustrating steps of a training method;

FIGS. 8A and 8B are block diagrams schematically illustrating a model for predicting geographic features, and a system for training the model;

FIG. 9 is a flow chart schematically illustrating steps of a method for training a model to predict geographic features;

FIG. 10 is a block diagram schematically illustrating a device for applying a trained model;

FIG. 11 is a block diagram schematically illustrating a device for training a model; and

FIGS. 12A to 12G are graphs illustrating an example application in prediction of short-term hail risk.

### DETAILED DESCRIPTION

In the application, several models are described as "first machine learning model", "second machine learning model", etc. Each model can exist independently, and the labels "first", "second", etc. are not indicative of any particular order. Machine learning models generally comprise model data such as weights, and a structured series of operations that are applied to the model data (optionally in combination with external data such as input values and random noise). For example, the model data may be used in a series of "layers" of interlinked mathematical calculations. The model data of a machine learning model may be stored and copied independently from the structured series of operations. For example, the structured series of operations may include a generic fully-interlinked neural network layer of nodes, and the model data may comprise one or more weights applied at each node. In this application, it should be understood that the described machine learning models may be stored, copied or communicated in the form of just the model data, or the complete machine learning model including the model data and the structured series of operations.

The described techniques are applicable to both of short-term atmospheric behavior ("weather") and longer-term atmospheric behavior ("climate"), and the term "local weather modifier" should be understood to encompass local modifiers to either or both of weather and climate.

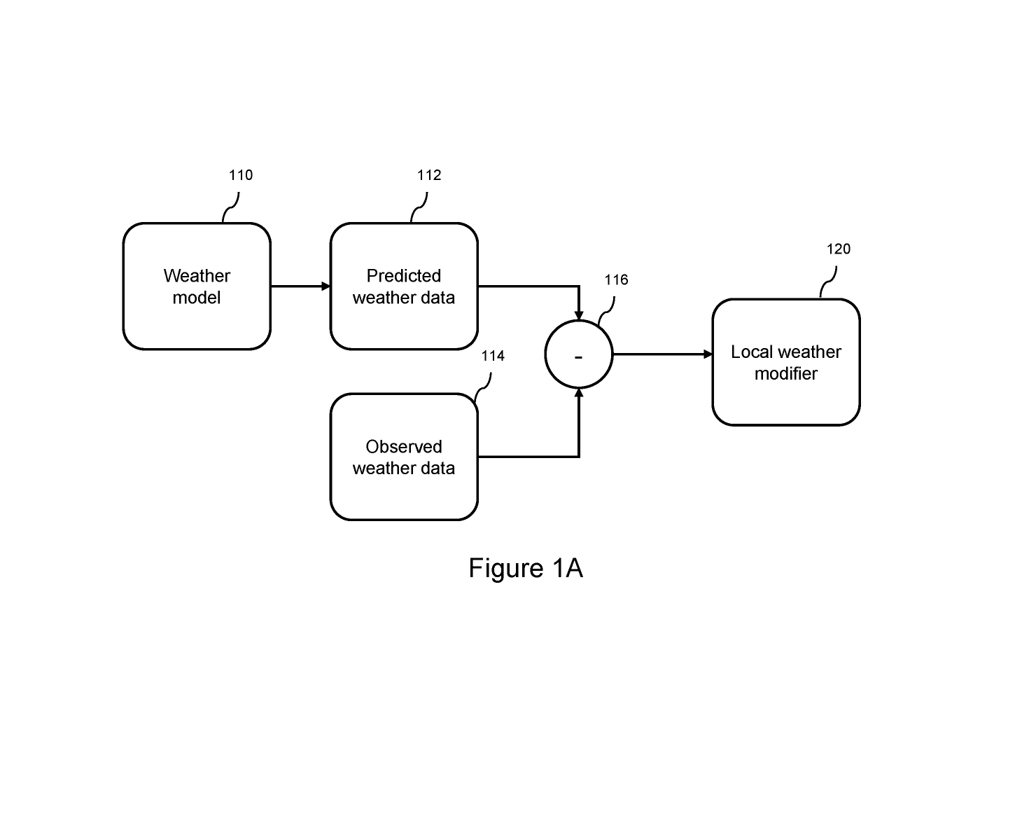

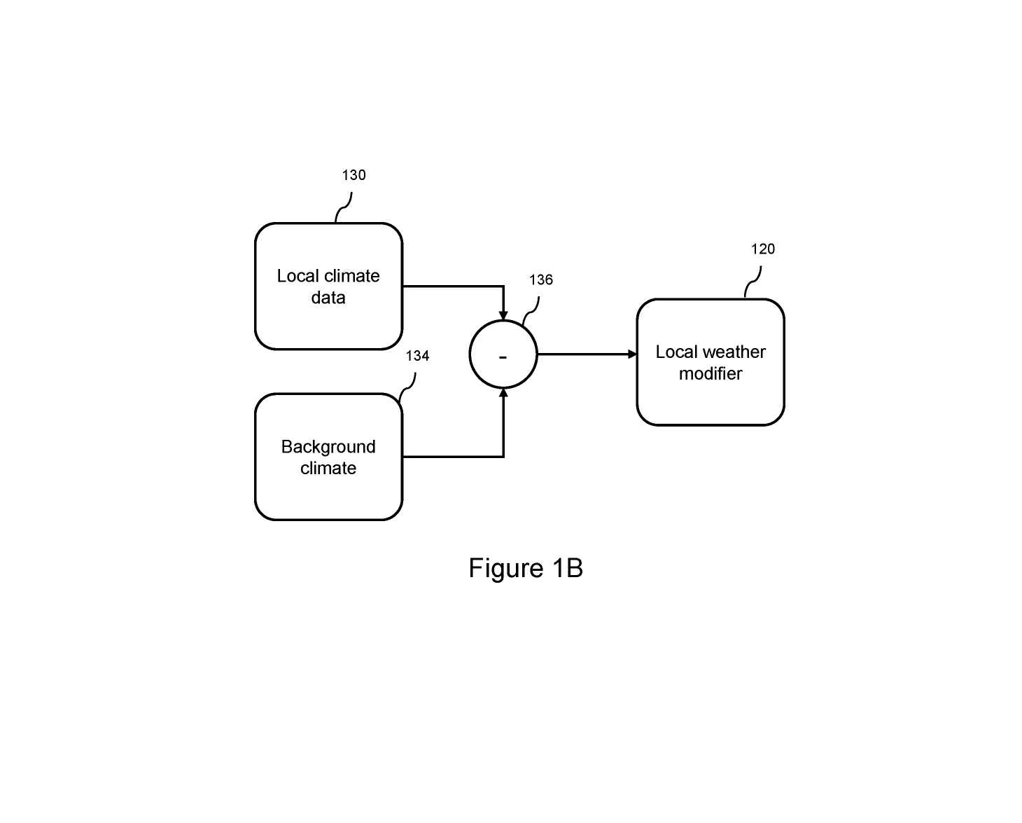

FIGS. 1A and 1B are flow diagrams useful to illustrate the concept of a local weather modifier.

Referring to FIG. 1A, typically when performing weather forecasting using common models (such as mesoscale or global models), a weather model 110 simulates pressure, temperature and other properties in the atmosphere in order to generate predicted weather data 112, such as forecast maps. The weather data may include, for example, predicted pressure, predicted temperature, predicted chance of precipitation and so on.

However, such weather models do not always account for local factors such as urban heat island effects, changes to air composition near highways or industrial sites, or natural effects due to, for example, nearby lakes or coastline. Any of these local factors can lead to differences between the predicted weather data 112 and observed weather data 114.

A local weather modifier 120 represents the effects of at least some of these local factors. In other words, the local weather modifier 120 can represent an expected difference 116 between the predicted weather data 112 and the observed weather data 114. The local weather modifier 120 may comprise modifier values for each of one or more raw model properties (such as pressure or temperature) and/or one or more calculated model properties (such as chance of precipitation or chance of hail).

The local weather modifier 120 may comprise a continuous field of modifier values at different locations in a geographical region. For example, the local weather modifier 120 may be calculated at the same resolution as the predicted weather data 112 and the observed weather data 114.

Alternatively, the local weather modifier 120 may comprise individual point modifier values at discrete locations within a geographical region. For example, each discrete location may be associated with a respective geographic feature within the geographical region. Alternatively, the local weather modifier 120 may comprise a local modifier field within a limited distance around each feature location of one or more geographic features. In other words, the local weather modifier 120 may represent a series of isolated locations or sub-regions in which weather is modified due to a geographic feature.

Geographic features may include, for example, urban geographic features such as cities, highways and factories, and/or natural geographic features such as rivers, lakes, hills and woodlands.

In many implementations, the geographic features have fixed ground locations. However, the concept of a local weather modifier can also be applied to mobile geographic features, such as nomadic settlements or icebergs.

The local weather modifier 120 may further comprise different modifier values at different times (such as different times of day, different seasons, etc.). The local weather modifier 120 may, for example, comprise values calculated as averages over a series of cycles, at different time points within the cycle.

The local weather modifier 120 may comprise modifier values in the form of absolute differences between expected and predicted data, proportional differences, a combination of the two. For example, when referring to temperature, it may be more relevant to look at absolute differences between local weather and modelled weather. On the other hand, when referring to the chance of precipitation, it may be more relevant to look at relative differences. Furthermore, aside from absolute or proportional differences, the local weather modifier 120 may comprise parameters for any linear or non-linear conversion function (such as a higher order polynomial or a local differential equation) to be applied to predicted data in order to improve the quality of the prediction – for example, specific conversion functions may be applied depending on the nature of the geographic features.

Once it has been obtained, the local weather modifier can be used to increase the accuracy of weather predictions (in the short term) or weather risk assessments (over a longer period).

As illustrated in FIG. 1A, one strategy for obtaining a local weather modifier 120 is to repeatedly obtain predictions 112 and observations 114, and calculate a static or time-dependent local weather modifier 120 based on the predictions and observations. However, this may require gathering data for each location of interest that is covered by the weather model 110, which may constrain scalability.

As illustrated in FIG. 1B, another strategy for obtaining a local weather modifier is a model-independent approach based on climate maps. In this strategy, differences 136 are identified between local climate data 130 and a background climate 134. Climate maps are available from organisations such as NOAA, and a difference 136 between "local climate" and "background climate" may, for example, be obtained by comparing a higher-resolution climate map to a lower-resolution climate map for the same region, or by applying a high-pass frequency filter to a single climate map.

In either of the above strategies, the identified differences between predictions and observations may be used literally as absolute or proportional differences in a local weather modifier 120, or may be further analysed. For example, it may be tested whether the identified differences can fit a specific conversion function, and parameters for the specific conversion function may be identified.

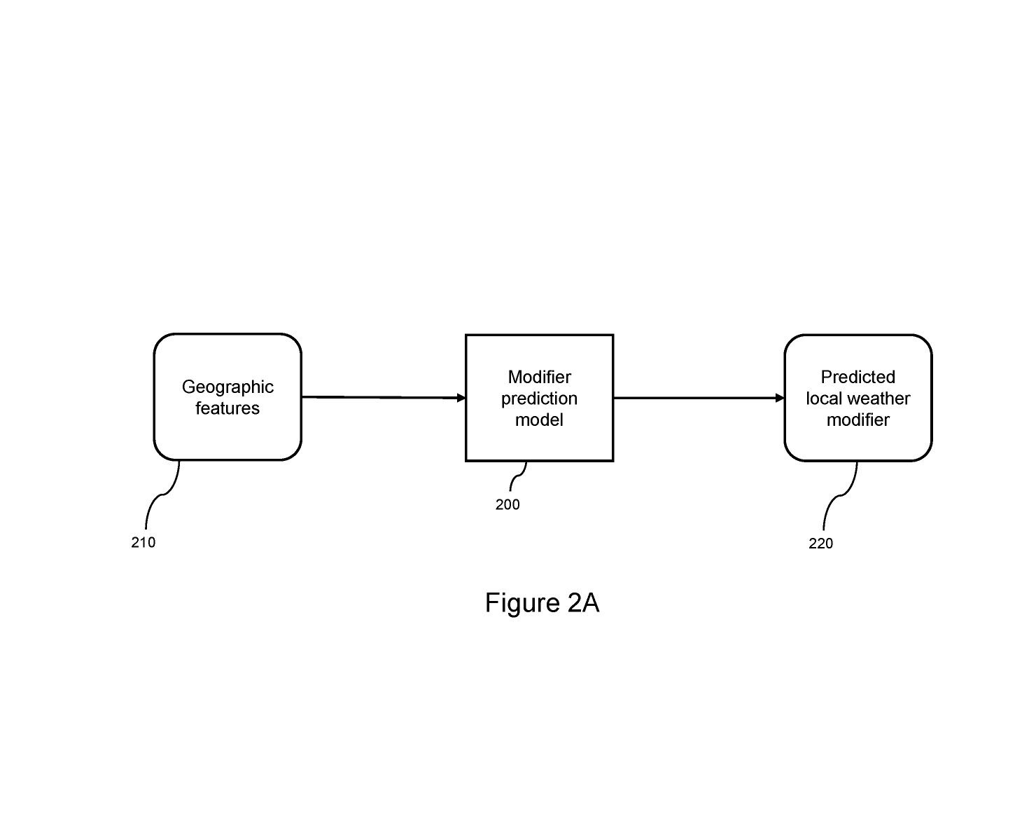

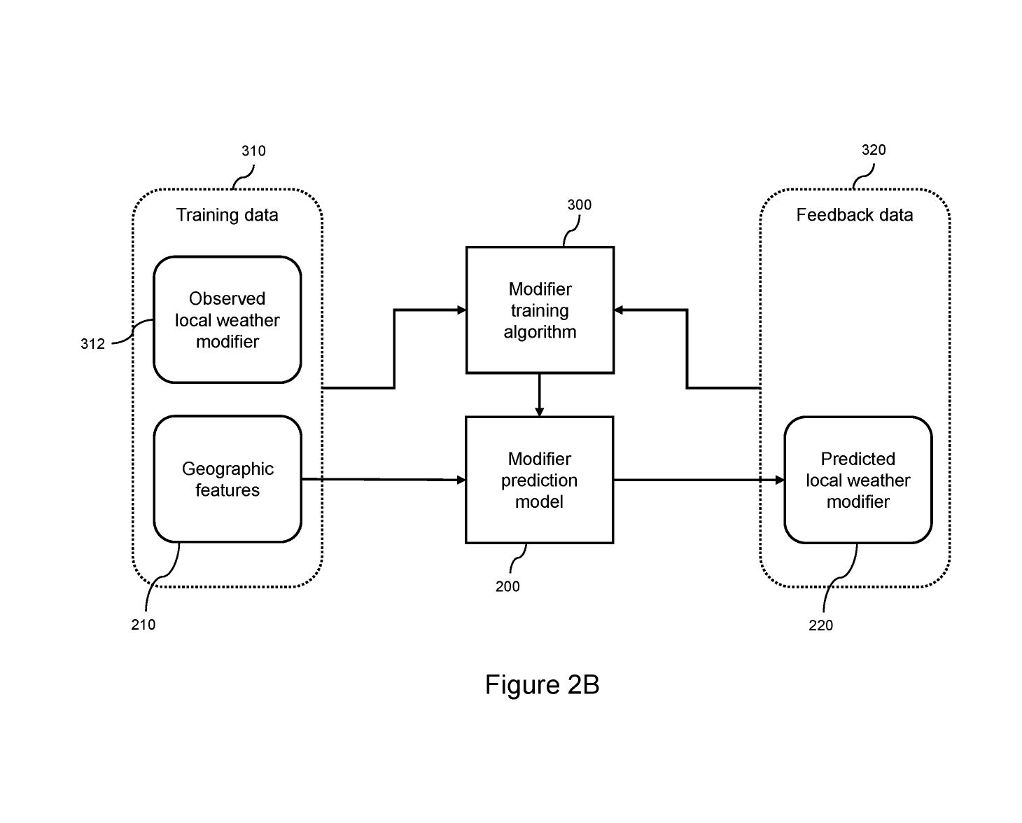

FIGS. 2A and 2B illustrate a further approach to obtaining a local weather modifier, based on machine learning.

Referring to FIG. 2A, a trained model 200 (here called a "modifier prediction model") receives one or more geographic features 210 as an input. Each geographic feature comprises at least a feature location and a feature property. The feature property may, for example, comprise a feature classification (e.g. building, lake, etc.) that may have been applied manually or via automatic classification. For example, the geographic features may be obtained from local maps. The feature property may additionally or alternatively comprise statistical data for the feature, such as population density or surface reflection/absorption characteristics. Additionally, a size of the feature may be defined as part of the feature location or the feature property.

The modifier prediction model 200 (aka "first machine learning model" in this specification) is a model trained to produce a predicted local weather modifier 220 as an output based on the received one or more geographic features 210. The model may have a form corresponding to any suitable known machine learning model. As mentioned above, machine learning models generally comprise model data such as weights, and a structured series of operations that are applied to the model data. The structured series of operations may, for example, comprise layers of a neural network. The model data may, for example, comprise weights associated with nodes of a neural network, for combining (e.g. multiplying and summing) values as data passes through the neural network.

A training process for training the modifier prediction model 200 is illustrated in FIG. 2B.

Referring to FIG. 2B, in this example process, a modifier training algorithm 300 is configured to adjust the modifier prediction model 200 based on training data 310 and feedback data 320.

The training data 310 comprises a plurality of training samples, each of which comprises a set of one or more geographic features 210 (i.e. a set of inputs for the model 200) and an observed local weather modifier 312 which represents the "true" modifier which would ideally be produced by the model 200 once it has been trained. The observed local weather modifier 312 for each training sample may, for example, be calculated using either of the above-described techniques shown in FIGS. 1A and 1B.

For each training sample in the training data 310, the one or more geographic features 210 are passed as inputs to the modifier prediction model 200 to obtain a predicted local weather modifier 220 as feedback data 320.

The modifier training algorithm 300 then obtains the training data 310 and the feedback data 320, and adjusts the modifier prediction model 200 based on a goal function. For example, the goal function may be to, for example, minimize an average difference between the observed local weather modifiers 312 and the predicted local weather modifiers 220 for the training data set. This process may be repeated for a plurality of variants of the modifier prediction model 200 in order to find minima of the goal function. Each variant of the model 200 may differ in terms of its model data and/or in terms of its structured operations. A set of variants may be generated randomly in order to compare a range of variants of the model 200. Additionally or alternatively, a variant of the model 200 may be varied on a systematic iterative basis, along an identified gradient of the goal function.

The above is merely one example of how a training algorithm can be organized, and many model structures and training algorithms are known to the skilled person, including training based on neural networks, support vector machines and decision tree algorithms. Furthermore, the training algorithm may comprise training individual layers and then combining the layers to form the model 200.

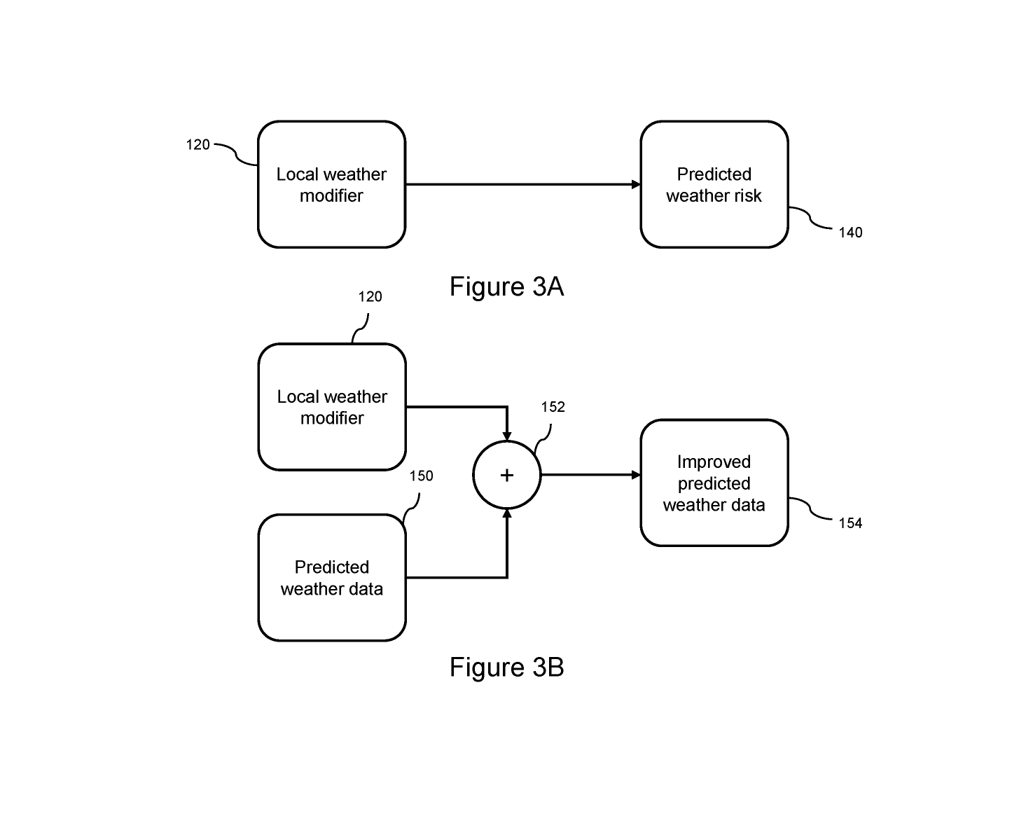

FIGS. 3A and 3B show two use cases for a local weather modifier (as observed or predicted by any of the above-described methods or any other suitable method).

In FIG. 3A, the local weather modifier is used to predict weather risks over a relatively long timescale, such as seasonal risk or annual risk. This predicted risk may then be used to assist with many weather-dependent activities such as building design and insurance assessments.

For example, as described above, the local weather modifier 120 may comprise different modifier values at different times (such as different times of day, different seasons, etc.). In such cases, the local weather modifier may be integrated over time to give a predicted weather risk 140 as an indication of how weather risks vary locally, as compared to standard climate data.

In FIG. 3B, the local weather modifier is used to increase the resolution or accuracy of short-term weather data.

More specifically, in FIG. 3B, weather data 150 is obtained for a geographical region. The weather data may comprise one or more weather images of the geographical region, the weather images indicating a weather state of the geographical region. The weather data 150 may for example be a conventional weather map for the region at a current time, or a weather forecast for the region at a future time.

This weather data 150 is combined 152 with the local weather modifier 120 to obtain improved predicted weather data 154. For example, the improved data 154 may represent a higher resolution prediction of current local weather in the geographical region, or a higher resolution prediction of future weather in the geographical region. The meaning of "combine" in the combination 152 may depend on how the local weather modifier is defined. As explained above, the local weather modifier may comprise an absolute modifier, a proportional modifier, or may generally define parameters for a conversion function to be applied to the weather data 150.

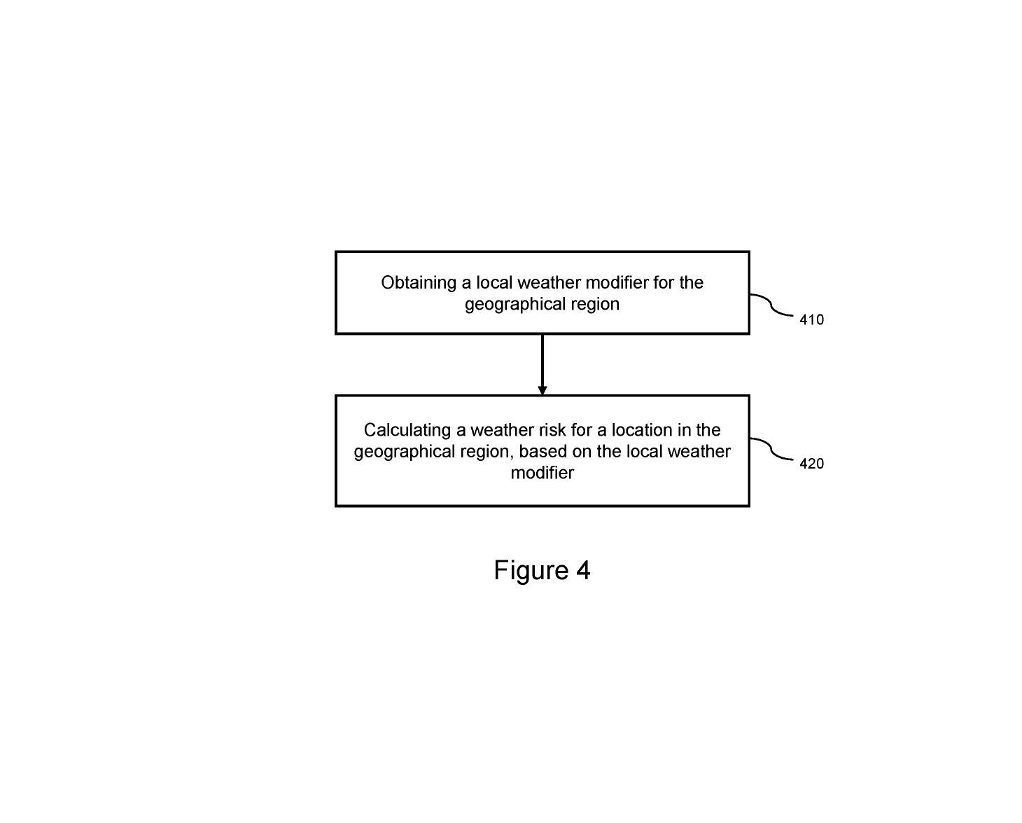

FIGS. 4 to 6 summarize major features of the above examples, in the form of further example methods.

FIG. 4 is a flow chart schematically illustrating steps of a method for predicting weather risk.

Referring to FIG. 4, at step 410, a local weather modifier is obtained for a geographical region. The local weather modifier may, for example, be a predicted local weather modifier obtained using a modifier prediction model 200 as shown in FIG. 2A. The local weather modifier may, for example, comprise a hail modifier indicating locally modified chance of hail or a storm modifier indicating a locally modified chance of storms.

Then, at step 420, a weather risk is calculated for a location in the geographical region, based on the local weather modifier. For example, the risk may comprise a risk over a period of time, such as seasonal risk or annual risk. This predicted risk may then be used to assist with many weather-dependent activities such as building design and insurance assessments.

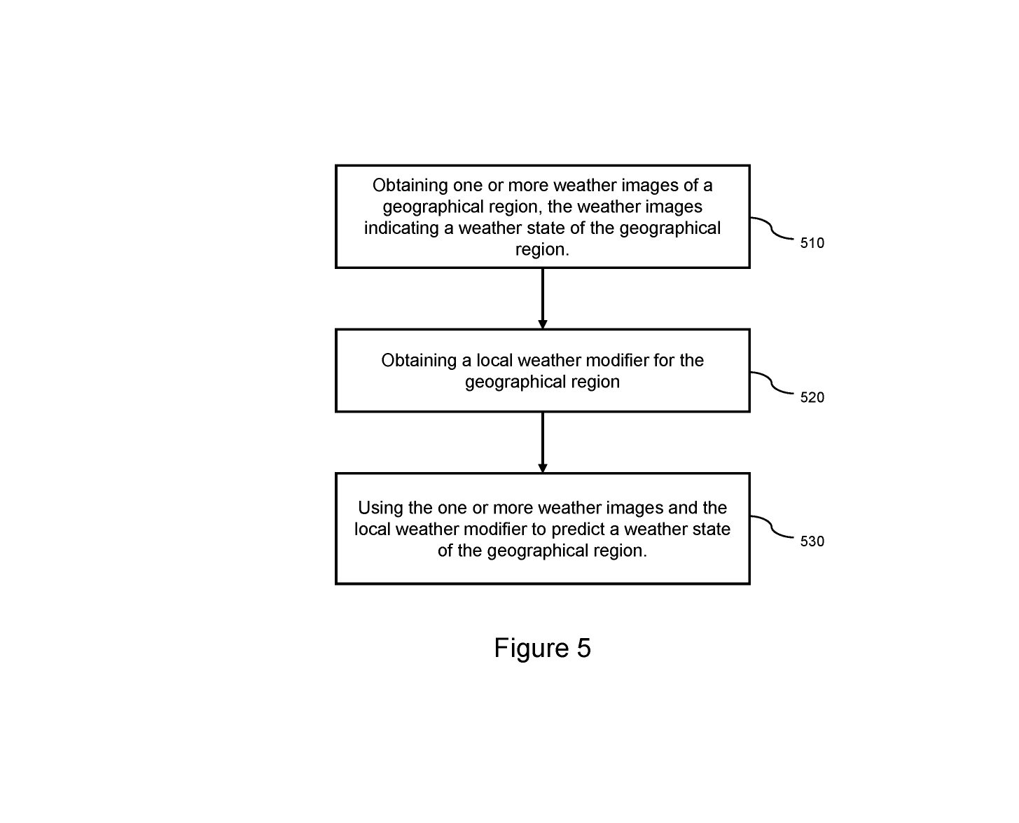

FIG. 5 is a flow chart schematically illustrating steps of a method for predicting weather.

Referring to FIG. 5, at step 510, one or more weather images of a geographical region are obtained. The weather images indicate a weather state of the geographical region. The weather data 150 may for example be a conventional weather map for the region at a current time, or a weather forecast for the region at a future time.

At step 520, a local weather modifier is obtained for the geographical region. The local weather modifier may, for example, be a predicted local weather modifier obtained using a modifier prediction model 200 as shown in FIG. 2A. The local weather modifier may, for example, comprise any one or more of a local temperature or pressure modifier, a precipitation modifier indicating locally modified chance of rain, a hail modifier indicating locally modified chance of hail or a storm modifier indicating a locally modified chance of storms.

At step 530, the one or more weather images are used together with the local weather modifier to predict a weather state of the geographical region. For example, predicted weather state may represent a higher resolution prediction of current local weather in the geographical region, or a higher resolution prediction of future weather in the geographical region. As explained above, the local weather modifier may comprise an absolute modifier, a proportional modifier, or may generally define parameters for a conversion function to be applied to the weather data 150.

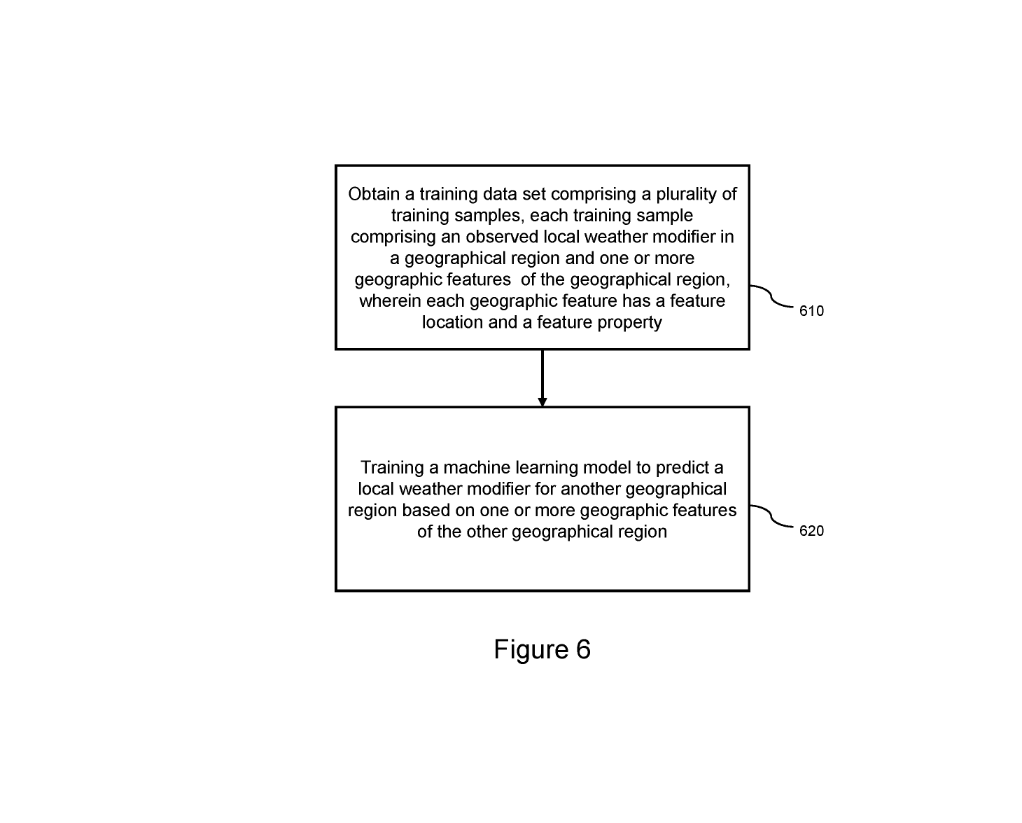

FIG. 6 is a flow chart schematically illustrating steps of a method for training a model to predict a local weather modifier.

Referring to FIG. 6, at step 610, a training data set is obtained comprising a plurality of training samples. Each training sample comprises an observed local weather modifier in a geographical region and one or more geographic features of the geographical region. Each geographic feature has a feature location and a feature property. For example, the training data set may correspond to the training data 310 illustrated in FIG. 2B.

At step 620, a machine learning model is trained to predict a local weather modifier for another geographical region based on one or more geographic features of the other geographical region. In other words, once the model has been trained on data for an initial set of one or more geographical regions associated with the training data, the model can then be used to make predictions regarding other geographical regions which were not associated with the training data.

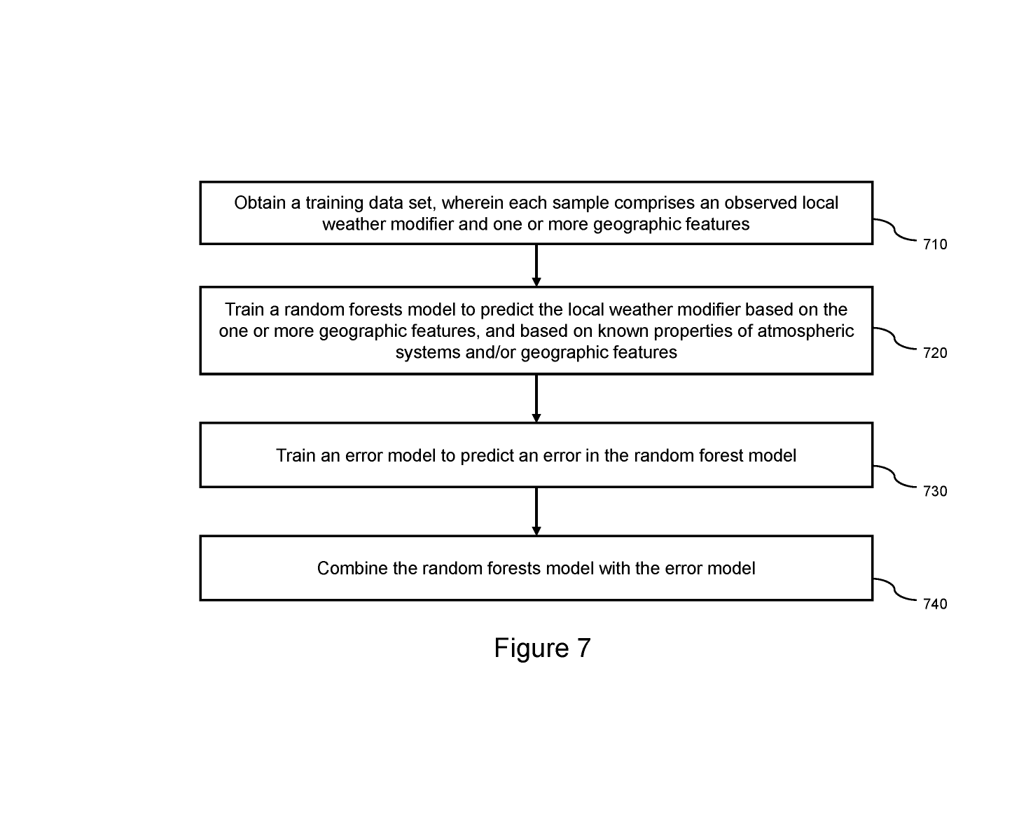

FIG. 7 shows another example of the training algorithm 300 for training the modifier prediction model 200. In this example, the training algorithm comprises a random forests algorithm.

Referring to FIG. 7, at step 710, a training data set is obtained, wherein each sample comprises an observed local weather modifier and one or more geographic features. This may be similar to the training data set 310 shown in FIG. 2B.

At step 720, a random forest model is trained to predict the local weather modifier based on the one or more geographic features, and based on known properties of atmospheric systems and/or geographic features.

More specifically, the training algorithm generates variants of a random forest model, wherein each variant comprises a respective plurality of decision tree structures for deciding a predicted local weather modifier output 220. The decision trees are generated based on known properties of atmospheric systems and/or geographic features.

The random forest model may be trained to minimize the difference between observed and predicted local weather modifiers, based on the known properties of atmospheric and/or geographic features, using training data 310 and feedback data 320.

However, there may be unknown behaviors in the system which mean that the optimized random forest model still does not predict the observed local weather modifier 312 to a desirable degree of accuracy, and there is some error in the predicted local weather modifiers 220 obtained using the trained random forest model.

Accordingly, at step 730, the training algorithm trains an error model to predict the error in the random forest model. The error model may, for example, comprise a general neural network which can be trained to model the unknown behaviors that are not predicted in the random forest model. The error model may be trained using the same training data, or different training data, from the data used in step 420.

Finally, at step 740, the trained local weather modifier 200 is constructed as a combination of the random forest model and the error model.

The configuration of FIG. 7 may result in a more efficient model, by using a more logically-constructed random forest model for a first stage of prediction, and only using a general neural network to account for a remaining error in the prediction.

### Feature prediction

The above-described techniques comprise predicting a local weather modifier based on one or more geographic features. This relationship between local weather and geographic features can also be exploited to identify geographic features using techniques similar to that described above. In other words, when observed local weather is different from predictions, this may be explained by the presence of a previously-unknown geographic feature, and a location and/or property of the geographic feature can be predicted based on the differences in the local weather modifier. Furthermore, a predicted geographic feature can be investigated to discover unmapped features such as factories (which can affect weather due to, for example, heat emission or particulate emissions).

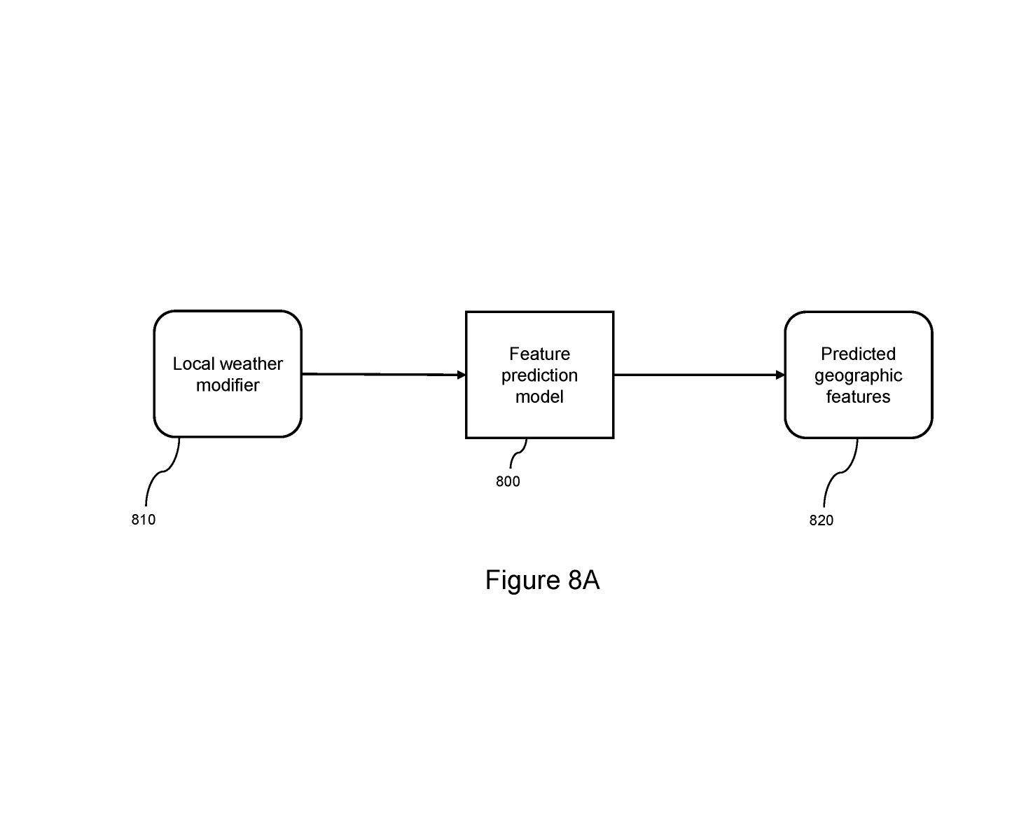

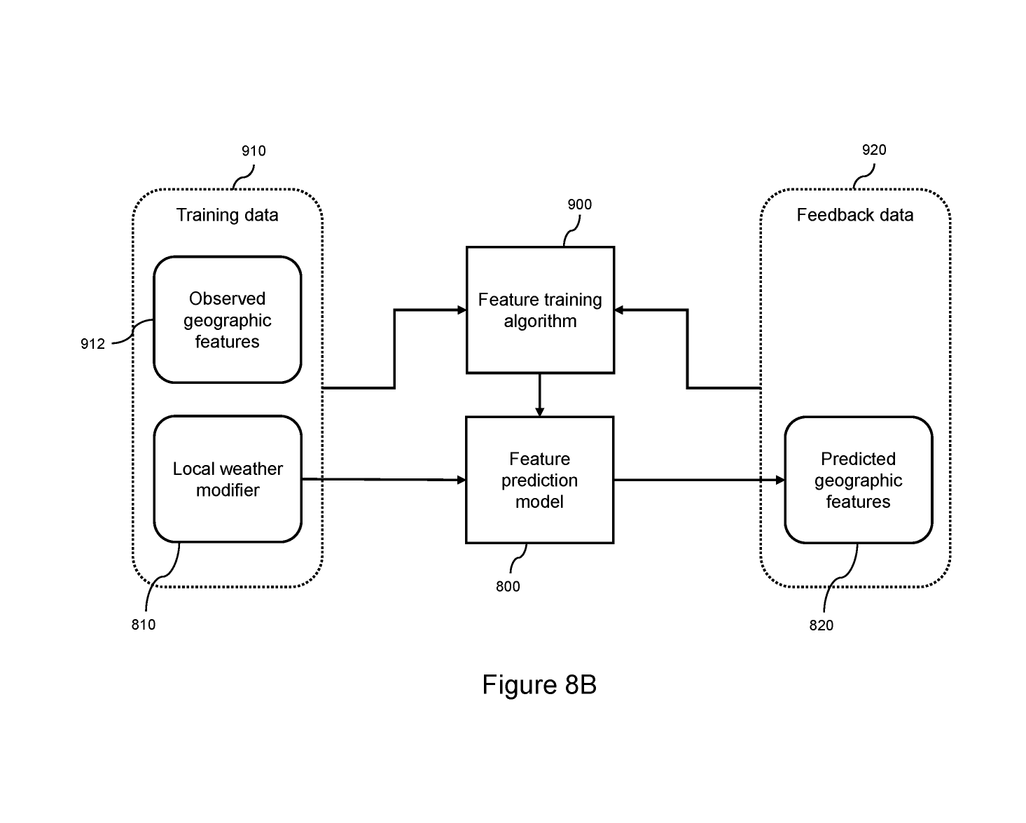

FIGS. 8A and 8B illustrate corresponding techniques for predicting one or more geographic features based on a local weather modifier.

Referring to FIG. 8A, a trained model 800 (here called a "feature prediction model") receives a local weather modifier 810 as an input. The local weather modifier may, for example, be obtained using a technique as illustrated in FIGS. 1A or 1B.

The feature prediction model 800 (aka "second machine learning model" in this specification) is a model trained to produce one or more geographic features 210 as an output. Each geographic feature comprises at least a feature location and a feature property. The feature property may, for example, comprise a feature classification (e.g. building, lake, etc.) that may have been applied manually or via automatic classification. For example, the geographic features may be obtained from local maps. The feature property may additionally or alternatively comprise statistical data for the feature, such as population density or surface reflection/absorption characteristics. Additionally, a size of the feature may be defined as part of the feature location or the feature property.

The feature prediction model may have a form corresponding to any suitable known machine learning model. As mentioned above, machine learning models generally comprise model data such as weights, and a structured series of operations that are applied to the model data. The structured series of operations may, for example, comprise layers of a neural network. The model data may, for example, comprise weights associated with nodes of a neural network, for combining (e.g. multiplying and summing) values as data passes through the neural network.

A training process for training the feature prediction model 800 is illustrated in FIG. 8B.

Referring to FIG. 8B, in this example process, a feature training algorithm 900 is configured to adjust the feature prediction model 800 based on training data 910 and feedback data 920.

The training data 910 comprises a plurality of training samples, each of which comprises a local weather modifier 810 (i.e. a set of inputs for the model 800) and a set of one or more observed geographic features 912 which represents the "true" features which would ideally be produced by the model 800 once it has been trained. The local weather modifier 810 for each training sample may, for example, be calculated using either of the above-described techniques shown in FIGS. 1A and 1B.

For each training sample in the training data 910, the local weather modifier 810 is passed as an input to the feature prediction model 800 to obtain a set of one or more predicted geographic features 820 as feedback data 920.

The feature training algorithm 900 then obtains the training data 910 and the feedback data 920, and adjusts the feature prediction model 800 based on a goal function. The goal function may be to, for example, minimize an average difference between the observed set of geographic features 912 and the predicted set of geographic features 820 for the training data set. This process may be repeated for a plurality of variants of the feature prediction model 800 in order to find minima of the goal function. Each variant of the model 800 may differ in terms of its model data and/or in terms of its structured operations. A set of variants may be generated randomly in order to compare a range of variants of the model 800. Additionally or alternatively, a variant of the model 800 may be varied on a systematic iterative basis, along an identified gradient of the goal function.

The above is merely one example of how a training algorithm can be organized to train the feature prediction model 800, and many model structures and training algorithms are known to the skilled person, including training based on neural networks, support vector machines and decision tree algorithms. Furthermore, the training algorithm may comprise training individual layers and then combining the layers to form the model 800.

### Computer implementations

The above-described techniques can generally be deployed using dedicated processing hardware, or using software executed by generic processing hardware, or a mixture of the two.

Furthermore, the above-described techniques can be deployed locally in a single device, or can be deployed in a networked environment comprising multiple devices in communication with each other. For example, the above-described techniques can be deployed as software executed in a virtual environment, independent from the underlying hardware, using processing resources of one or more devices in a network.

For example, some or all features of the above-described techniques can be coded as compiled processor instructions or as human-readable instructions using a programming language such as Python. Such instructions may be stored and deployed using a non-volatile storage medium such as a portable solid state memory device and/or communicated as a data signal. Furthermore model data of a trained machine learning model may be stored and deployed using a non-volatile storage medium such as a portable solid state memory device and/or communicated as a data signal.

A result from the above described techniques may optionally be displayed using a mapping software. Suitable mapping software for displaying a local weather modifier or a prediction based on a local weather modifier includes the ArcGIS and QGIS platforms.

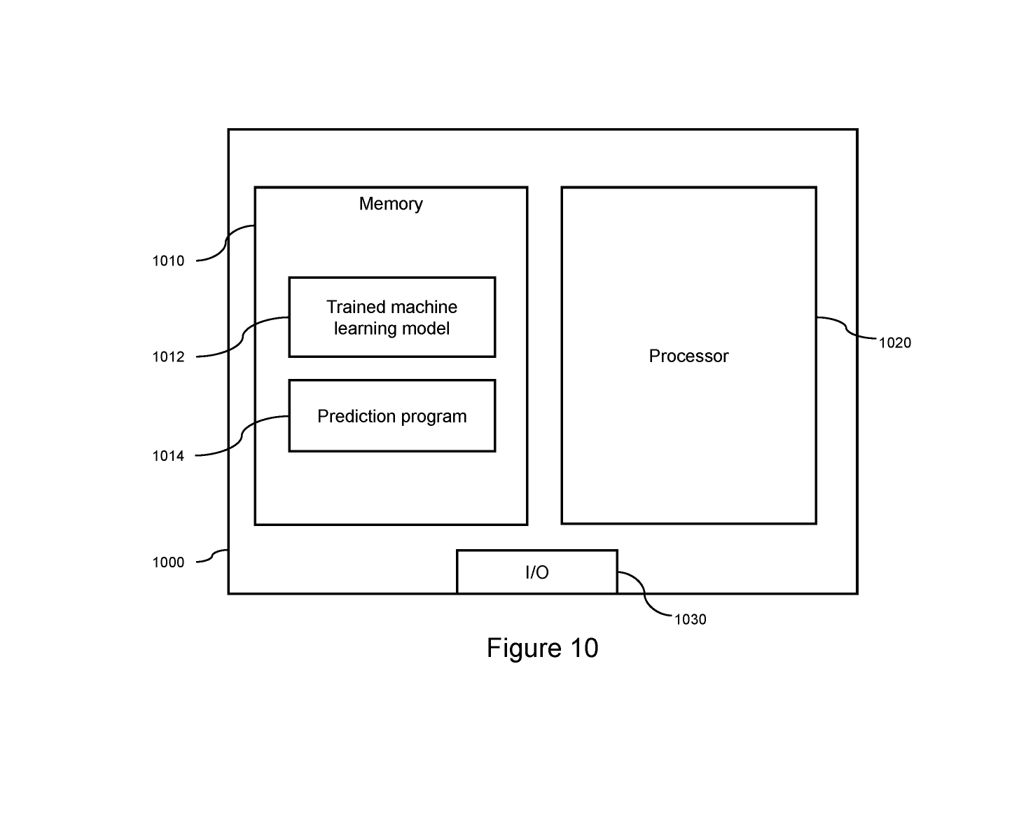

FIG. 10 is a block diagram schematically illustrating a device 1000 for applying a trained model.

The device 1000 comprises one or more memories 1010 and one or more processors 1020. The memories may comprise a volatile memory, a non-volatile memory and/or a combination of volatile and non-volatile memories. The one or more memories 1010 and one or more processors 1020 may be distributed across multiple locations. In other words, the device 1000 may be a distributed device comprising multiple networked elements. Alternatively, the device 1000 may be a single apparatus at a single location.

The one or more memories 1010 store a trained machine learning model 1012. This may be, for example, the modifier prediction model 200 trained according to the techniques described with reference to FIG. 2B or the feature prediction model 800 trained according to the techniques described with reference to FIG. 8B.

The trained machine learning model 1012 is stored in at least one of the memories 1010 and may be split into a plurality of components stored in the same or different memories 1010.

The one or more memories 1010 may also store a prediction program 1014. The prediction program 1014 may provide an interface for converting input data into a required format for the model 1012, and/or an interface for converting output data from the model 1012. The prediction program 1014 may also include software for executing a structured series of operations associated with the model in order to obtain an output based on an input. In other words, the prediction program 1014 provides instructions for the one or more processors 1020 to perform a prediction operation using the model 1012. For example, the prediction program may define any combination of the above described methods as illustrated in any of FIGS. 2A, 3A, 3B, 4, 5 and 8A.

The device 1000 may further comprise an external data interface 1030 for receiving inputs and or transmitting outputs. This may, for example, be used to provide predictions remotely to users.

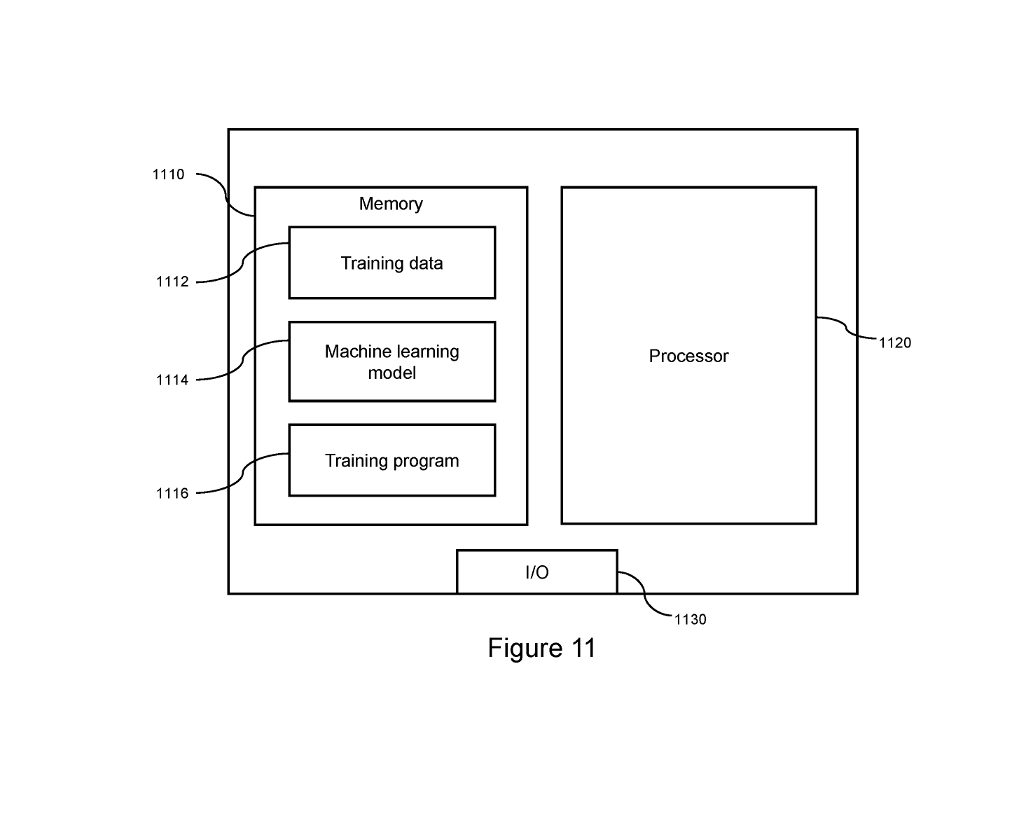

FIG. 11 is a block diagram schematically illustrating a device for training a model.

The device 1100 comprises one or more memories 1110 and one or more processors 1120. The memories may comprise a volatile memory, a non-volatile memory and/or a combination of volatile and non-volatile memories. The one or more memories 1110 and one or more processors 1120 may be distributed across multiple locations. In other words, the device 1100 may be a distributed device comprising multiple networked elements. Alternatively, the device 1100 may be a single apparatus at a single location.

The one or more memories 1110 store training data 1112. This training data may comprise, for example, training data 310 as discussed above with respect to FIG. 2B and/or training data 910 as discussed above with respect to FIG. 8B.

The one or more memories 1110 store a machine learning model 1114 as it is being trained. This may be, for example, the modifier prediction model 200 trained according to the techniques described with reference to FIG. 2B or the feature prediction model 800 trained according to the techniques described with reference to FIG. 8B. An initial state of the machine learning model 1114 may be random, or may be a predetermined initial state, depending on the training method, as discussed above.

The machine learning model 1114 is stored in at least one of the memories 1110 and may be split into a plurality of components stored in the same or different memories 1110.

The one or more memories 1110 also store a training program 1116.

The training program 1116 may provide an interface for converting input data into a required format for the model 1114, and/or an interface for converting output data from the model 1114.

The training program 1116 may also include software for executing a structured series of operations associated with the model in order to obtain an output based on an input. In other words, the training program 1116 provides instructions for the one or more processors 1120 to perform a prediction operation using the model 1112.

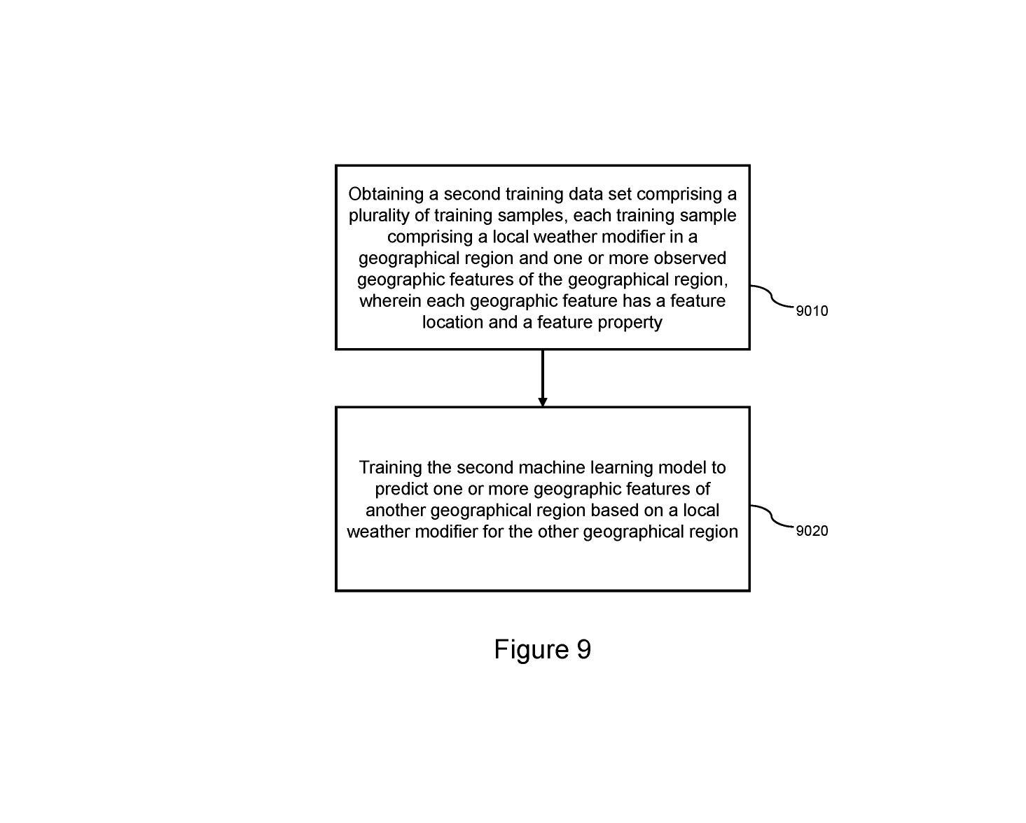

Additionally, the training program 1116 may comprise software for generating variants of the model 1114 and for training, comparing and/or pruning variants of the model 1114 in order to identify an improved trained model. For example, the prediction program may define any combination of the above-described methods as illustrated in any of FIGS. 2B, 6, 7, 8B and 9.

Additionally, the training program may define any combination of any of the above-described methods in the application. In other words, the device 1100 may be capable of acting as both a training device and a prediction device.

The device 1100 may further comprise an external data interface 1130 for receiving inputs and or transmitting outputs. This may, for example, be used to control the training remotely. For example, hardware for training may be allocated dynamically as and when it is needed. In such cases, the training data, machine learning model and training program may be copied to and stored in the device 1100 only for as long as necessary to perform the training.

### Example results

The above-described techniques have numerous applications in weather and climate analysis on a local level, including for short-term weather predictions and longer-term risk analysis.

One application which has been initially explored in detail by the applicants is in predicting the risk of hail, at a higher resolution than has previously been possible.

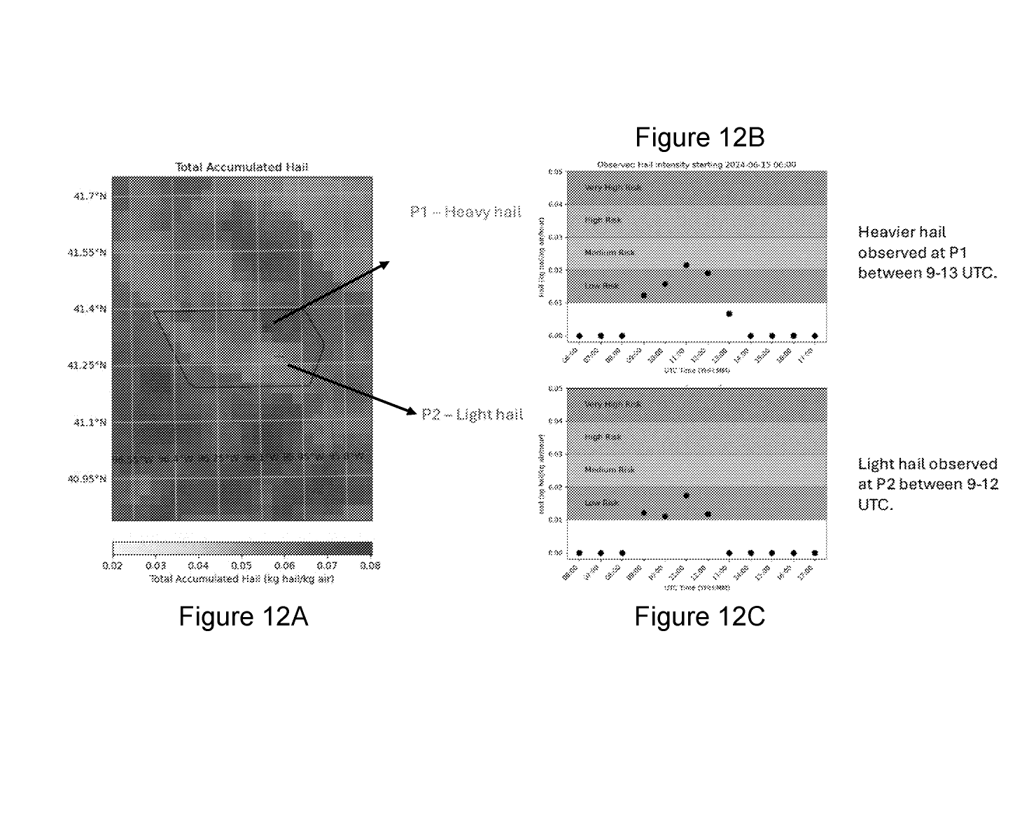

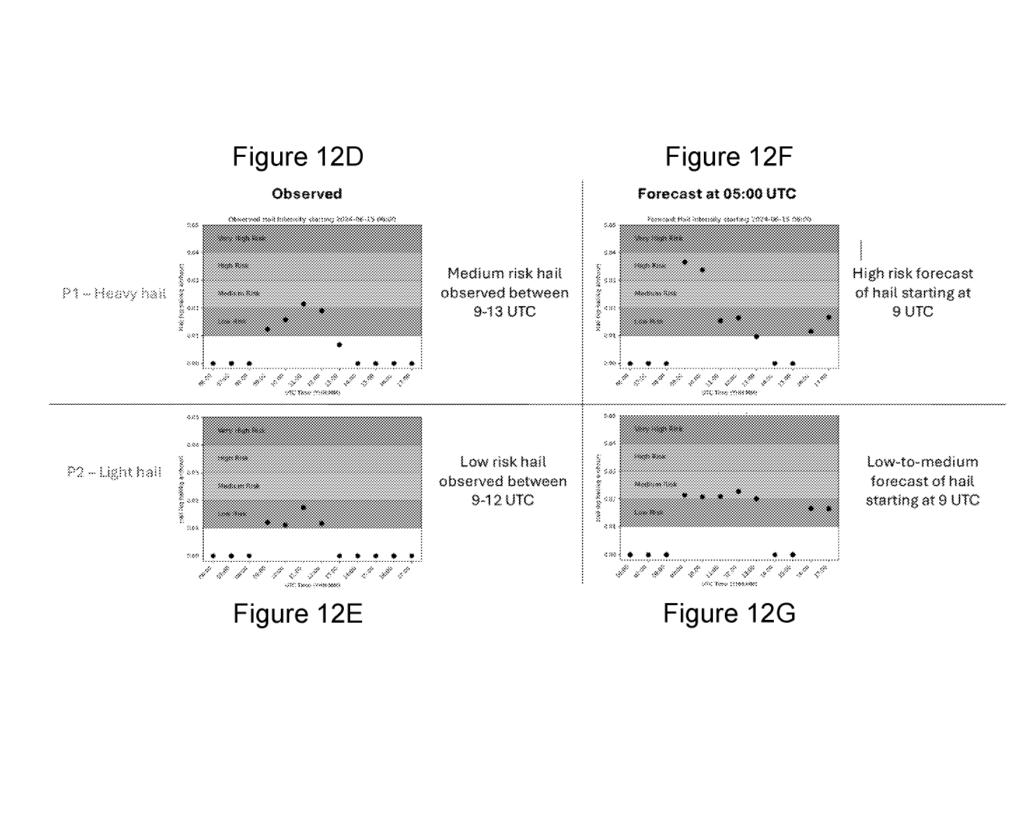

FIGS. 12A to 12G are graphs illustrating an example application in prediction of short-term hail risk.

Referring to FIG. 12A, this is a graph of total accumulated hail in the atmosphere as measured using RADAR imaging during a storm in Douglas County, Nebraska on June 15, 2024. The polygon outline in the middle of the figure is the outline of Douglas County, which has a North-South length of about 14 miles. Douglas County contains Omaha city, and hail prediction is of interest for purposes such as predicting storm damage in the city. The figure is also labelled with latitude and longitude to indicate the distance scales in the horizontal (East- West) and vertical (North-South) directions. Total accumulated hail is indicated in the graph as a heat map, according to the scale shown at the bottom of the figure.

As shown in FIG. 12A, a North-Eastern region of Douglas County experienced relatively high total accumulated hail in the atmosphere, while regions further to the south and west experienced lower total accumulated hail in the atmosphere.

Two locations P1 and P2 are marked with crosses on the map of FIG. 12A. The observed hail intensity (i.e. the hail falling to the ground) was measured at each of these locations over the course of the day.

Referring to FIG. 12B, the location P1 experienced relatively heavy hail, with a maximum intensity of just over 0.02 kg hail / kg air / hour in the middle of the day. FIG. 12B also shows categories assigned based on the hail intensity scale, where the peak hail intensity is classified as "medium risk".

Referring to FIG. 12C, the location P2 experienced relatively light hail, where the peak hail intensity is classified as "low risk" (0.01 < Hail < 0.02, in units of kg hail / kg air / hour).

FIGS. 12D and 12E are the same as FIGS. 12B and 12C, but are reproduced on the next page for convenient comparison to FIGS. 12E and 12F.

FIGS. 12F and 12G show predictions made using an experimental embodiment of the invention, to provide weather predictions that take into account a local weather modifier. These predictions were all made at the beginning of the day.

The predictions include a significant difference between hail expectations at location P1 (FIG. 12F) and location P2 (FIG. 12G), with FIG. 12F predicting higher hail intensity at location P1. This corresponds to the observed results, in which hail had higher intensity at location P1 (FIG. 12D) than P2 (FIG. 12E).

Additionally, by comparison to the resolution limits of conventional meso-scale maps, it is apparent that predictions according to the described techniques are detailed enough to show very low spatial correlation in the predicted data, even between the locations P1 and P2, which are only around 5 miles apart from each other.

The subject-matter of the application additionally includes the following clauses:

### Model training methods

A computer-implemented method of training a first machine learning model to determine a local weather modifier, the method comprising: obtaining a first training data set comprising a plurality of training samples, each training sample comprising an observed local weather modifier in a geographical region and one or more geographic features of the geographical region, wherein each geographic feature has a feature location and a feature property; training the first machine learning model to predict a local weather modifier for another geographical region based on one or more geographic features of the other geographical region.

A computer-implemented method of training a second machine learning model to determine a geographical feature, the method comprising: obtaining a second training data set comprising a plurality of training samples, each training sample comprising a local weather modifier in a geographical region and one or more observed geographic features of the geographical region, wherein each geographic feature has a feature location and a feature property; and training the second machine learning model to predict one or more geographic features of another geographical region based on a local weather modifier for the other geographical region.

A method according to clause 1 or clause 2, further comprising, for each training sample: calculating the observed local weather modifier as a difference between predicted weather data generated using a weather model and observed weather data, in the respective geographical region.

A method according to clause 1 or clause 2, further comprising, for each training sample: calculating the observed local weather modifier as a difference between a climate map for the geographical region and a background climate.

A method according to any preceding clause, wherein training the first or second machine learning model comprises using a random forests algorithm .

A method according to any preceding clause, wherein the one or more geographic features comprise an urban geographic feature.

A method according to any preceding clause, wherein each feature location is a fixed ground feature location.

### Deployment of models

A computer-implemented method of weather risk assessment comprising: obtaining a local weather modifier for a geographical region; and calculating a weather risk for a location in the geographical region, based on the local weather modifier.

A computer-implemented method of weather prediction comprising: obtaining one or more weather images of a geographical region, the weather images indicating a weather state of the geographical region; obtaining a local weather modifier for the geographical region; using the one or more weather images and the weather modification property field to predict a weather state of the geographical region.

A method according to clause 9, wherein the weather images indicate a state of the geographical region in a first time period, and the predicted weather state is a predicted weather state of the geographical region at a second time later than the first time period.

A method according to clause 9 or clause 10, wherein the one or more weather images comprise a weather radar image.

A method according to any of clauses 8 to 11, wherein the local weather modifier is obtained by: obtaining one or more geographic features for the geographic region, each geographic feature comprising a feature location and a feature type; and using a first machine learning model to determine the local weather modifier based on the one or more geographic features.

A method according to clause 12, wherein the first machine learning model is trained according to the method of any of clauses 1 and 3 to 7.

A method according to any preceding clause, wherein the local weather modifier is a modifier field corresponding to the geographical region.

A method according to any preceding clause, wherein the local weather modifier comprises a point modifier for each feature location of one or more geographic features .

A method according to any preceding clause, wherein the local weather modifier comprises a local modifier field around each feature location of one or more geographic features.

A method according to any preceding clause, wherein the local weather modifier comprises a hail modifier.

A method according to any preceding clause, wherein the local weather modifier comprises a storm modifier.

### Systems for training and/or deploying models

A computer-implemented system for training a first machine learning model to determine a local weather modifier, the system being configured to: obtain a first training data set comprising a plurality of training samples, each training sample comprising an observed local weather modifier in a geographical region and one or more geographic features of the geographical region, wherein each geographic feature has a feature location and a feature property; and train the first machine learning model to predict a local weather modifier for another geographical region based on one or more geographic features of the other geographical region.

A computer-implemented system for training a second machine learning model to determine a geographical feature, the system being configured to: obtain a second training data set comprising a plurality of training samples, each training sample comprising a local weather modifier in a geographical region and one or more observed geographic features of the geographical region, wherein each geographic feature has a feature location and a feature property; and train the second machine learning model to predict one or more geographic features of another geographical region based on a local weather modifier for the other geographical region.

A system according to clause 19 or clause 20, further configured to, for each training sample: calculate the observed local weather modifier as a difference between predicted weather data generated using a weather model and observed weather data, in the respective geographical region.

A system according to clause 20 or clause 21, further configured to, for each training sample: calculate the observed local weather modifier as a difference between a climate map for the geographical region and a background climate.

A system according to any of clauses 19 to 22, wherein training the first or second machine learning model comprises using a random forests algorithm .

A system according to any of clauses 19 to 23, wherein the one or more geographic features comprise an urban geographic feature.

A system according to any of clauses 19 to 24, wherein each feature location is a fixed ground feature location.

A computer-implemented system for weather risk assessment, the system being configured to: obtain a local weather modifier for a geographical region; and calculate a weather risk for a location in the geographical region, based on the local weather modifier.

A computer-implemented system for weather prediction, the system being configured to: obtain one or more weather images of a geographical region, the weather images indicating a weather state of the geographical region; obtain a local weather modifier for the geographical region; use the one or more weather images and the weather modification property field to predict a weather state of the geographical region.

A system according to clause 27, wherein the weather images indicate a state of the geographical region in a first time period, and the predicted weather state is a predicted weather state of the geographical region at a second time later than the first time period.

A system according to clause 27 or clause 28, wherein the one or more weather images comprise a weather radar image.

A system according to any of clauses 26 to 29, wherein the local weather modifier is obtained by: obtaining one or more geographic features for the geographic region, each geographic feature comprising a feature location and a feature type; and using a first machine learning model to determine the local weather modifier based on the one or more geographic features.

A system according to clause 30, wherein the first machine learning model is trained according to the method of any of clauses 1 and 3 to 7.

A system according to any of clauses 19 to 31, wherein the local weather modifier is a modifier field corresponding to the geographical region.

A system according to any of clauses 19 to 32, wherein the local weather modifier comprises a point modifier for each feature location of one or more geographic features .

A system according to any of clauses 19 to 33, wherein the local weather modifier comprises a local modifier field around each feature location of one or more geographic features.

A system according to any of clauses 19 to 34, wherein the local weather modifier comprises a hail modifier.

A system according to any of clauses 19 to 35, wherein the local weather modifier comprises a storm modifier.

### Computer programs for training and/or deploying models

A computer program comprising instructions which, when executed by a computer system, cause the system to perform a method of training a first machine learning model to determine a local weather modifier, the method comprising: obtaining a first training data set comprising a plurality of training samples, each training sample comprising an observed local weather modifier in a geographical region and one or more geographic features of the geographical region, wherein each geographic feature has a feature location and a feature property; training the first machine learning model to predict a local weather modifier for another geographical region based on one or more geographic features of the other geographical region.

A computer program comprising instructions which, when executed by a computer system, cause the system to perform a computer-implemented method of training a second machine learning model to determine a geographical feature, the method comprising: obtaining a second training data set comprising a plurality of training samples, each training sample comprising a local weather modifier in a geographical region and one or more observed geographic features of the geographical region, wherein each geographic feature has a feature location and a feature property; and training the second machine learning model to predict one or more geographic features of another geographical region based on a local weather modifier for the other geographical region.

A computer program according to clause 37 or clause 38, further comprising, for each training sample: calculating the observed local weather modifier as a difference between predicted weather data generated using a weather model and observed weather data, in the respective geographical region.

A computer program according to clause 37 or clause 38, further comprising, for each training sample: calculating the observed local weather modifier as a difference between a climate map for the geographical region and a background climate.

A computer program according to any of claims 37 to 40, wherein training the first or second machine learning model comprises using a random forests algorithm.

A computer program according to any of claims 37 to 41, wherein the one or more geographic features comprise an urban geographic feature.

A computer program according to any of claims 37 to 42, wherein each feature location is a fixed ground feature location.

A computer program comprising instructions which, when executed by a computer system, cause the system to perform a method of weather risk assessment comprising: obtaining a local weather modifier for a geographical region; and calculating a weather risk for a location in the geographical region, based on the local weather modifier.

A computer program comprising instructions which, when executed by a computer system, cause the system to perform a method of weather prediction comprising: obtaining one or more weather images of a geographical region, the weather images indicating a weather state of the geographical region; obtaining a local weather modifier for the geographical region; using the one or more weather images and the weather modification property field to predict a weather state of the geographical region.

A computer program according to clause 45, wherein the weather images indicate a state of the geographical region in a first time period, and the predicted weather state is a predicted weather state of the geographical region at a second time later than the first time period.

A computer program according to clause 45 or clause 46, wherein the one or more weather images comprise a weather radar image .

A computer program according to any of clauses 44 to 47, wherein the local weather modifier is obtained by: obtaining one or more geographic features for the geographic region, each geographic feature comprising a feature location and a feature type; and using a first machine learning model to determine the local weather modifier based on the one or more geographic features.

A computer program according to clause 48, wherein the first machine learning model is trained according to the method of any of clauses 1 and 3 to 7.

A computer program according to any of clauses 37 to 49, wherein the local weather modifier is a modifier field corresponding to the geographical region.

A computer program according to any of clauses 37 to 50, wherein the local weather modifier comprises a point modifier for each feature location of one or more geographic features .

A computer program according to any of clauses 37 to 51, wherein the local weather modifier comprises a local modifier field around each feature location of one or more geographic features.

A computer program according to any of clauses 37 to 52, wherein the local weather modifier comprises a hail modifier.

A computer program according to any of clauses 37 to 53, wherein the local weather modifier comprises a storm modifier.

### Storage media for method instructions

A non-transitory storage medium storing computer-readable instructions which, when executed by a computer system, cause the system to perform a method of training a first machine learning model to determine a local weather modifier, the method comprising: obtaining a first training data set comprising a plurality of training samples, each training sample comprising an observed local weather modifier in a geographical region and one or more geographic features of the geographical region, wherein each geographic feature has a feature location and a feature property; training the first machine learning model to predict a local weather modifier for another geographical region based on one or more geographic features of the other geographical region.

A non-transitory storage medium storing computer-readable instructions which, when executed by a computer system, cause the system to perform a computer-implemented method of training a second machine learning model to determine a geographical feature, the method comprising: obtaining a second training data set comprising a plurality of training samples, each training sample comprising a local weather modifier in a geographical region and one or more observed geographic features of the geographical region, wherein each geographic feature has a feature location and a feature property; and training the second machine learning model to predict one or more geographic features of another geographical region based on a local weather modifier for the other geographical region.

A storage medium according to clause 55 or clause 56, further comprising, for each training sample: calculating the observed local weather modifier as a difference between predicted weather data generated using a weather model and observed weather data, in the respective geographical region.

A storage medium according to clause 55 or clause 56, further comprising, for each training sample: calculating the observed local weather modifier as a difference between a climate map for the geographical region and a background climate.

A storage medium according to any of claims 55 to 58, wherein training the first or second machine learning model comprises using a random forests algorithm.

A storage medium according to any of claims 55 to 59, wherein the one or more geographic features comprise an urban geographic feature.

A storage medium according to any of claims 55 to 60, wherein each feature location is a fixed ground feature location.

A non-transitory storage medium storing computer-readable instructions which, when executed by a computer system, cause the system to perform a method of weather risk assessment comprising: obtaining a local weather modifier for a geographical region; and calculating a weather risk for a location in the geographical region, based on the local weather modifier.

A non-transitory storage medium storing computer-readable instructions which, when executed by a computer system, cause the system to perform a method of weather prediction comprising: obtaining one or more weather images of a geographical region, the weather images indicating a weather state of the geographical region; obtaining a local weather modifier for the geographical region; using the one or more weather images and the weather modification property field to predict a weather state of the geographical region.

A storage medium according to clause 63, wherein the weather images indicate a state of the geographical region in a first time period, and the predicted weather state is a predicted weather state of the geographical region at a second time later than the first time period.

A storage medium according to clause 63 or clause 64, wherein the one or more weather images comprise a weather radar image.

A storage medium according to any of clauses 62 to 65, wherein the local weather modifier is obtained by: obtaining one or more geographic features for the geographic region, each geographic feature comprising a feature location and a feature type; and using a first machine learning model to determine the local weather modifier based on the one or more geographic features.

A storage medium according to clause 66, wherein the first machine learning model is trained according to the method of any of clauses 1 and 3 to 7.

A storage medium according to any of clauses 55 to 67, wherein the local weather modifier is a modifier field corresponding to the geographical region.

A storage medium according to any of clauses 55 to 68, wherein the local weather modifier comprises a point modifier for each feature location of one or more geographic features .

A storage medium according to any of clauses 55 to 69, wherein the local weather modifier comprises a local modifier field around each feature location of one or more geographic features.

A storage medium according to any of clauses 55 to 70, wherein the local weather modifier comprises a hail modifier.

A storage medium according to any of clauses 55 to 71, wherein the local weather modifier comprises a storm modifier.

### Models per se

A trained machine learning model for determining a local weather modifier for a geographic region based on one or more geographic features, each geographic feature comprising a feature location and a feature type.

A model according to claim 73, wherein the model is trained according to the method of any of claims 1 and 3 to 7.

A non-transitory storage medium storing a model according to clause 73 or clause 74.

A trained machine learning model for determining one or more geographic features for a geographic region based on a local weather modifier, each geographic feature comprising a feature location and a feature type.

A model according to clause 76, wherein the model is trained according to the method of any of clauses 2 to 7.

A non-transitory storage medium storing a model according to clause 76 or clause 77.

1. A computer-implemented method of training a first machine learning model to determine a local weather modifier, the method comprising:
obtaining a first training data set comprising a plurality of training samples, each training sample comprising an observed local weather modifier in a geographical region and one or more geographic features of the geographical region, wherein each geographic feature has a feature location and a feature property;
training the first machine learning model to predict a local weather modifier for another geographical region based on one or more geographic features of the other geographical region.

2. A computer-implemented method of training a second machine learning model to determine a geographical feature, the method comprising:
obtaining a second training data set comprising a plurality of training samples, each training sample comprising a local weather modifier in a geographical region and one or more observed geographic features of the geographical region, wherein each geographic feature has a feature location and a feature property; and
training the second machine learning model to predict one or more geographic features of another geographical region based on a local weather modifier for the other geographical region.

3. A method according to claim 1, further comprising, for each training sample:
calculating the observed local weather modifier as a difference between predicted weather data generated using a weather model and observed weather data, in the respective geographical region.

4. A method according to claim 1, further comprising, for each training sample:
calculating the observed local weather modifier as a difference between a climate map for the geographical region and a background climate.

5. A method according to claim 1, wherein training the first machine learning model comprises using a random forests algorithm.

6. A method according to claim 1, wherein the one or more geographic features comprise an urban geographic feature.

7. A method according to claim 1, wherein each feature location is a fixed ground feature location.

8. A computer-implemented method of weather risk assessment comprising:
obtaining a local weather modifier for a geographical region; and
calculating a weather risk for a location in the geographical region, based on the local weather modifier.

9. A computer-implemented method of weather prediction comprising:
obtaining one or more weather images of a geographical region, the weather images indicating a weather state of the geographical region;
obtaining a local weather modifier for the geographical region;
using the one or more weather images and the local weather modifier to predict a weather state of the geographical region.

10. A method according to claim 9, wherein the weather images indicate a state of the geographical region in a first time period, and the predicted weather state is a predicted weather state of the geographical region at a second time later than the first time period.

11. A method according to claim 9, wherein the one or more weather images comprise a weather radar image.

12. A method according to claim 8, wherein the local weather modifier is obtained by:
obtaining one or more geographic features for the geographic region, each geographic feature comprising a feature location and a feature type; and
using a first machine learning model to determine the local weather modifier based on the one or more geographic features.

13. A method according to claim 12, wherein the first machine learning model is trained according to a method comprising:
obtaining a first training data set comprising a plurality of training samples, each training sample comprising an observed local weather modifier in a geographical region and one or more geographic features of the geographical region, wherein each geographic feature has a feature location and a feature property;
training the first machine learning model to predict a local weather modifier for another geographical region based on one or more geographic features of the other geographical region.

14. A method according to claim 8, wherein the local weather modifier is a modifier field corresponding to the geographical region.

15. A method according to claim 8, wherein the local weather modifier comprises a point modifier for each feature location of one or more geographic features.

16. A method according to claim 8, wherein the local weather modifier comprises a local modifier field around each feature location of one or more geographic features.

17. A method according to claim 8, wherein the local weather modifier comprises a hail modifier.

18. A method according to claim 8, wherein the local weather modifier comprises a storm modifier.

19. A method according to claim 2, wherein training the second machine learning model comprises using a random forests algorithm.
